(19) United States
(12) Patent Application Publication
(10) Pub. No.: US 2012/0129042 A1
(43) Pub. Date: May 24, 2012

(54) BATTERY MODULE

(75) Inventor: Tomoyoshi Kurahashi, Tokyo (JP)

(73) Assignee: MITSUBISHI HEAVY INDUSTRIES, LTD., Tokyo (JP)

(21) Appl. No.: 13/302,049

(22) Filed: Nov. 22, 2011

(30) Foreign Application Priority Data
Nov. 24, 2010 (JP) 2010-261475

(51) Int. Cl. H01M 2/22

(52) U.S. Cl. 429/158

(57) ABSTRACT

A battery module includes: a first electrical cell and a second electrical cell, each including a battery case having an electrode terminal with one between a concave portion and a convex portion; a fixing member for fitting to the one; and an interconnection member including an interconnection material, a waterproof resin for covering the interconnection material other than a portion that the interconnection material contacts the electrode terminal, and a first projection extending from the waterproof resin and formed around the contact portion, wherein the interconnection member is fixed between the first and the second electrical cells by the fitting, and the first projection surrounds the electrode terminal to improve air-tightness of the interconnection member.

Priority is claimed on Japanese Patent Application No. 2010-261475, filed on Nov. 24, 2010, the content of which is incorporated herein by reference.

### BACKGROUND OF THE INVENTION

1. Field of the Invention

The present invention relates to a battery module.

2. Description of Related Art

A battery module having a plurality of electrical cells connected to each other through an interconnection member is used in various environments. Depending on the environment in which the battery module is used, a battery module with a waterproof property is required. For example, a battery module may be placed at a lower part of an electric system (e.g., a ship) mounted with the battery module. When water enters into such an electric system, there is an increasing possibility that the battery module may be exposed to moisture or the water.

Therefore, a conventional battery module having an improved waterproof property has been developed (refer to Japanese Patent Application Laid-Open No. H9-129202). In the battery module disclosed in Japanese Patent Application Laid-Open No. H9-129202, a partition wall is provided around a lead (i.e., the interconnection member) connecting two electrical cells to each other, and the inside of the partition wall is filled with an insulating resin. As a result, an electrode terminal and the lead are sealed by the insulating resin, and the electrode terminal and the lead become waterproof.

According to the conventional battery module, a certain level of waterproof performance can be achieved. However, in a case that the battery module is applied to an external force, such as vibration, the partition wall may rise from the predetermined contact portion between the electrode terminal and a battery case. Therefore, water may be leaked from a crack to the electrode terminal. In this case, the electrode terminal or the interconnection member is exposed to the moisture or the water, and they may become rusty. Therefore, the performance of the conventional battery module may deteriorate.

Further, since the inside of the partition wall is filled with the insulating resin covering the electrode terminal and the interconnection member, it is not easy to separate the electrode terminal and the interconnection member during the maintenance such as the replacement of the electrical cell. Thus, in the conventional battery module, the maintenance of the conventional battery module is troublesome and takes longer time. It means that the effectiveness for the maintenance is deteriorated.

### SUMMARY OF THE INVENTION

The present invention is made in view of such circumstances. The object of the present invention is to provide a battery module having a waterproof property and improved the effectiveness for the maintenance of a contacting portion between an electrode terminal and an interconnection member, and having an excellent battery performance.

An aspect of the present invention is a battery module comprising: a first electrical cell and a second electrical cell, each including a battery case having an electrode terminal with one between a concave portion and a convex portion; a fixing member for fitting to the one; and an interconnection member including an interconnection material, a waterproof resin for covering the interconnection material other than a portion that the interconnection material contacts the electrode terminal, and a first projection extending from the waterproof resin and formed around the contact portion, wherein the interconnection member is fixed between the first and second electrical cells by the fitting, and the first projection surrounds the electrode terminal to improve air-tightness of the interconnection member.

In the battery module of the present invention, the first electrical cell and the second electrical cell are connected to each other through the interconnection member and are fixed by the fixing member. The first projection is formed on the interconnection member. The first projection surrounds the electrode terminal of the electrical cell to improve air-tightness. Accordingly, the waterproof property of the battery module is improved.

Further, since the fixing member is fitted to the concave portion or the convex portion formed in the electrode terminal, the first electrical cell and the second electrical cell can be separated from the interconnection member by separating the fixing member from the concave portion or the convex portion easily. Therefore, the maintenance of the battery module is easy.

According to the aspect of the present invention, a battery module having both of the waterproof property and the effectiveness of the maintenance at the same time and having an excellent battery performance can be provided.

### BRIEF DESCRIPTION OF THE DRAWINGS

FIG. 1 illustrates a configuration of a battery module as a first embodiment.

FIG. 2A illustrates a cross-sectional view with taken along the line A-A′ of FIG. 1, and FIG. 2B illustrates an enlarged cross-sectional view for a main part of FIG. 2A.

FIG. 3 illustrates a cross-sectional view for a first modified example of the battery module of FIG. 1.

FIG. 4 illustrates a cross-sectional view for a second modified example of the battery module of FIG. 1.

FIG. 5A illustrates a cross-sectional view for a battery module as a second embodiment, FIG. 5B is an exploded diagram of FIG. 5A.

FIG. 6 illustrates a part of the battery module as the second embodiment.

### DETAILED DESCRIPTION OF THE INVENTION

Hereinafter, exemplary embodiments according to the present invention will be described by referring to the accompanying drawings. The technical scope of the invention is not limited to the embodiments or the modified examples below The respective components described in the embodiments or the modified examples below may be appropriately combined with each other. In the drawings, the dimensions or the scales of the structures may be different from those of the actual structures, for conveniences for describing characteristic points of the embodiments. The same reference numerals are given to the same components in the embodiments, and the detailed description thereof may not be repeated.

### First Embodiment

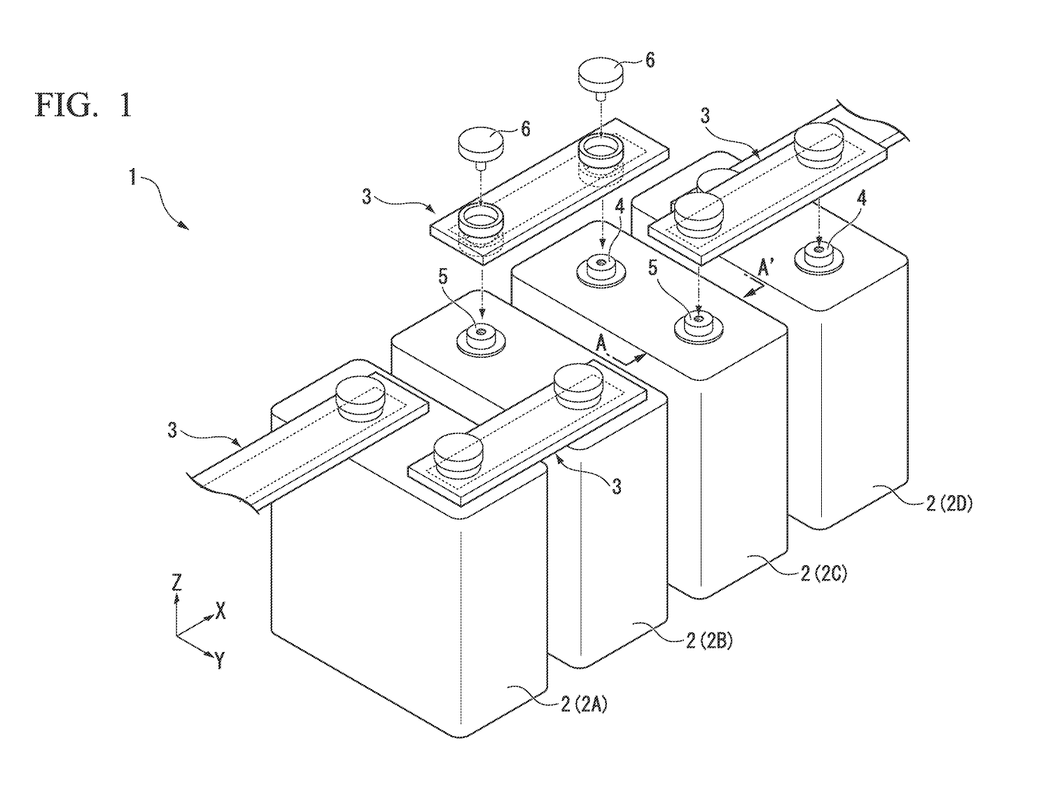

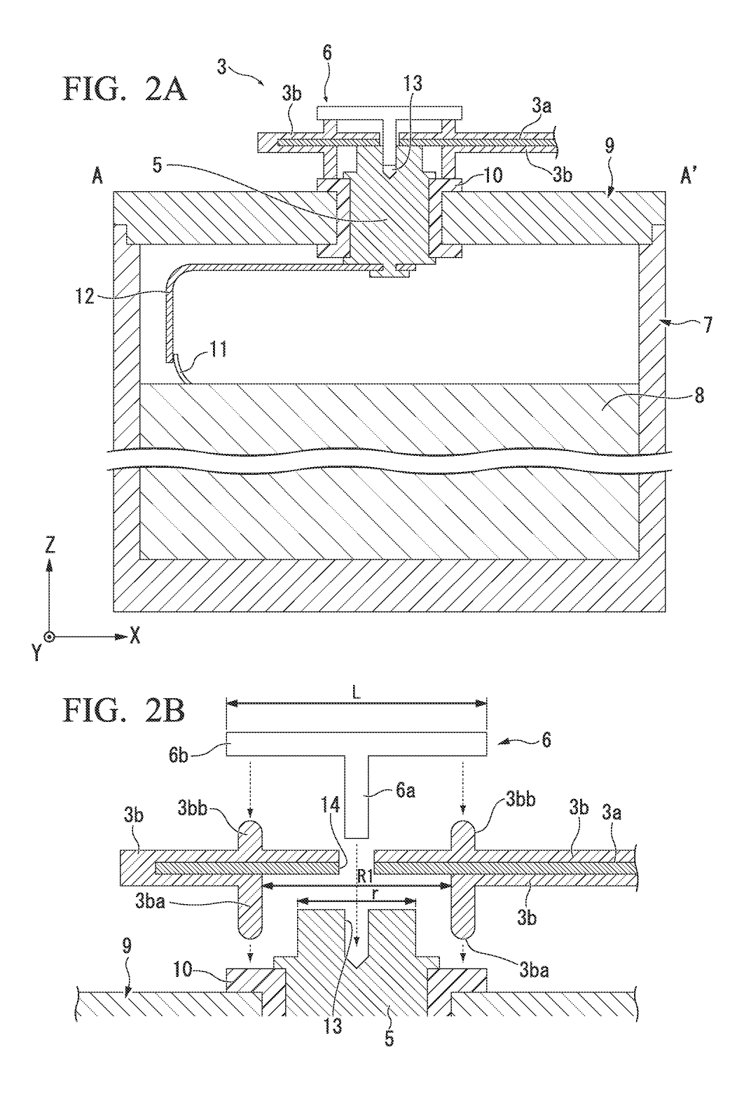

Referring to FIGS. 1, 2A, and 2B, a battery module as a first embodiment of the invention will be described. In these drawings, the same orthogonal coordinate system is used.

First, the battery module 1 of the present embodiment is shown in FIG. 1. In the battery module 1, a plurality of electrical cells 2 such as lithium ion secondary batteries are fixed and connected electronically to each other through the interconnection members 3. On the electrical cells 2, electrode terminals (i.e., a positive electrode terminal and a negative electrode terminal) are formed. On the electrode terminal, a concave portion (e.g., a hole for screwing a screw or the like) is formed. The fixing member 6 (e.g., a male screw or the like) has a convex portion that fits to the concave portion, and fixes the plurality of electrical cells 2 through the interconnection member 3.

Specifically, four electrical cells 2 (which are referred to as electrical cells 2A, 2B, 2C, and 2D in the X direction for convenience of description), which are of the same type and which have the same structure, are electrically connected to each other in series. In the connection, a positive electrode terminal 4 of the electrical cell 2A having a square battery case is electrically connected to a positive electrode terminal for the use of the battery module 1 (not shown) (or a positive electrode terminal of a power load such as an electric motor driven by the battery module 1) through an interconnection member 3. Also, a negative electrode terminal 5 of the electrical cell 2A is electrically connected to a positive electrode terminal 4 of the electrical cell 2B through the interconnection member 3. Also, a negative electrode terminal 5 of the electrical cell 2B is electrically connected to a positive electrode terminal 4 of the electrical cell 2C through the interconnection member 3. Further, a negative electrode terminal 5 of the electrical cell 2C is electrically connected to a positive electrode terminal 4 of the electrical cell 2D through the interconnection member 3. Furthermore, a negative electrode terminal 5 of the electrical cell 2D is electrically connected to a negative electrode terminal for the use of the battery module 1 (not shown) (or a negative electrode terminal of the power load) through the interconnection member 3.

Next, referring to FIGS. 2A and 2B, a configuration of the electrical cell 2, a structure of the interconnection member 3, and a connection between the interconnection member 3 and the electrode terminal will be described in detail. Here, the electrode terminal is described by exemplifying the negative electrode terminal 5, but the positive electrode terminal 4 has the same structure. Accordingly, in the description below, the negative electrode terminal 5 may be read as the electrode terminal (i.e., the positive electrode terminal 4 or the negative electrode terminal 5).

FIG. 2A is a cross-sectional view with taken along the line A-A′ of FIG. 1. The electrical cell 2 includes: a square case body 7 that has a substantially rectangular shape on the XY plane and that has walls extending in the Z direction from all sides of the substantially rectangular shape; a stacked electrode body 8 that is stored in the case body 7 and that is formed by stacking a positive electrode plate and a negative electrode plate with a separator interposed between them; and a cover 9 that seals the case body 7 after the stacked electrode body 8 is stored in the case body 7 (“a battery case” is formed by sealing the case body 7 with the cover 9).

In the cover 9, the negative electrode terminal 5 passing through the cover 9 and having a cylindrical shape (with a circular cross-section substantially having a diameter “r”), and an insulating resin 10 (e.g., a plastic resin or the like) fixing the negative electrode terminal 5 to the cover 9 and electrically insulating the negative electrode terminal 5 and the cover 9, are formed. In the negative electrode terminal 5, a concave portion 13 (e.g., a tapped hole or the like) is formed, that is a recess or a hollow caved to the −Z direction, at a position near the center of the circle outside the battery case.

The stacked electrode body 8 may be for a stacked type of which a battery has a plurality of positive electrode plates and a plurality of negative electrode plates sequentially stacked each other through separators, or for a winding type of which a battery has one positive electrode plate and one negative electrode plate are stacked and wound through a separator. A negative electrode tab 11 formed at the negative electrode plate of the stacked electrode body 8 is connected to a negative electrode lead 12, and the negative electrode lead 12 is riveted to the negative electrode terminal 5 inside the battery case. Therefore, the negative electrode plate and the negative electrode terminal 5 are electrically connected to each other. Although there are not any diagrams related to a positive electrode plate in the drawings, a positive electrode tab formed at the positive electrode plate of the stacked electrode body 8 is connected to a positive electrode lead, and the positive electrode lead is riveted to the positive electrode terminal 4 inside the battery case. Therefore, the positive electrode plate and the positive electrode terminal 4 are electrically connected to each other.

The fixing member 6 includes a convex portion 6a fitted to the concave portion 13 of the negative electrode terminal 5, and a head portion 6b connected to the convex portion 6a and having a substantially T-shaped cross-section in the XZ plane with the convex portion 6a. Furthermore, the shape of the head portion 6b in the XY plane is a substantially circular shape with a diameter “L” of which the center is positioned to the convex portion 6a. The convex portion 6a and the head portion 6b may be formed as one body by using a mold and made of metal or resin such as plastic.

The interconnection member 3 includes a bus-bar 3a and a waterproof resin 3b. The bus-bar 3 is a conductive interconnection material (e.g., metal) formed in a flat plate shape having two through-holes 14 each of that are arranged at each end of the shape respectively. The diameter of the through-hole 14 is substantially the same to that of the concave portion 13 or slightly larger. The waterproof resin 3b (e.g., rubber or the like) covers the entire surface of bus-bar 3a, other than the through-holes 14 and other than the area within the range of a radius of (R1)/2 on the XY plane from each of the centers of the through-holes 14 on the rear surface, which is the surface of the bus-bar 3a near the electrical cell 2 between two surfaces of the bus-bar 3a. That is, the surface is positioned to the −Z direction.

“The range of a radius of (R1)/2 on the XY plane from each of the centers of two through-holes on the rear surface of the bus-bar 3a” (the range is referred to as “a contact portion”) is a portion for physically contacting to a surface (i.e., the front surface) of the negative electrode terminal 5, which is a surface that the concave portion 13 is formed, and for forming an electric path between the bus-bar 3a and the negative electrode terminal 5. Accordingly, the relation between the diameter “r” of the negative electrode terminal 5 and the diameter “R1” of the contact portion becomes (R1)>r.

Further, the entire circumference of the contact portion of the interconnection member 3 is provided with a first projection 3ba which works as a so-called O-ring and which has a substantially circular shape in the XY plane. The first projection 3ba is formed with the resin 3b as one body.

The height (i.e., the height along the Z direction) of the first projection 3ba is designed to be such a height (a height capable of accomplishing a function of a so-called O-ring by applying a pressure), that the first projection 3ba applies a pressure to the battery case with sufficiently and evenly contacting the battery case, and that maintains the state of air-tightness in the portion surrounded by the first projection 3ba sufficiently, when the contact portion of the interconnection member 3 is contacted to the front surface of the negative electrode terminal 5.

Furthermore, a second projection 3bb is formed with the resin 3b as one body on the front surface of the bus-bar 3a. The surface is opposite to the contact portion of the bus-bar 3a. That is, the surface is positioned to the +Z direction. And, the second projection 3bb is substantially formed at the same position on the XZ plane as that of the first projection 3ba. As illustrated in FIG. 2B, the height of the second projection 3bb is designed to be such a height (a height capable of accomplishing a function of a so-called O-ring by applying a pressure), that the second projection 3bb sufficiently and evenly contacts the head portion 6b of the fixing member 6, and that maintains the state of air-tightness in the portion surrounded by the second projection 3bb, when the convex portion 6a of the fixing member 6 is inserted into the through-hole 14 of the interconnection member 3 and the convex portion 6a is fitted to the concave portion 13 of the negative electrode terminal 5 to apply the pressure to the −Z direction. Accordingly, in this case, L>(R1) is satisfied.

The first projection 3ba and the second projection 3bb are both formed of a waterproof and elastic material, which is the same material as the resin 3b, and may be integrally formed with the resin 3b as one body using a mold. Further, in FIGS. 2A and 2B, because the front surface portion of the bus-bar 3a located at a position corresponding to the contact portion is also covered by the resin 3b on the XY plane, the waterproof property is further improved.

Accordingly, when two electrical cells 2 are fixed by using the interconnection member 3 and the fixing member 6, the state of air-tightness of the electric path between the electrical cells 2 is highly and sufficiently maintained because of the combination of the waterproof resin 3b, the first projection 3ba, and the second projection 3bb of the interconnection member 3. Therefore, the battery module exhibits excellent performance.

When the convex portion 6a of the fixing member 6 is formed of an elastic resin such as rubber, and in a case that the diameter of the convex portion 6a is set to be substantially equal to or slightly larger than the diameter of the concave portion 13 of the negative electrode terminal 5, the interconnection member 3 may be reliably fixed to the electrical cell 2 and the air-tightness may be highly maintained by applying a pressure with pressing the fixing member 6 toward the negative electrode terminal 5.

Further, when the concave portion 13 of the negative electrode terminal 5 is a female screw and the convex portion 6a of the fixing member 6 is a male screw engaging with the female screw, the first projection 3ba and the second projection 3bb is more strongly pressed by turning the male screw into the female screw until the male screw do not go any further. Accordingly, the function as the O-ring is further improved, and the air-tightness is further highly maintained.

Furthermore, when the convex portion 6a of the fixing member 6 is formed of an elastic resin or when the convex portion 6a is a male screw, the interconnection member 3 can be easily separated from the negative electrode terminal 5. Therefore, the working efficiency for the maintenance of the battery module becomes extremely satisfaied.

As described above, in the first embodiment, a battery module has both of the excellent waterproof property and the excellent maintenance workability. Therefore, the battery module in the first embodiment has excellent battery performance.

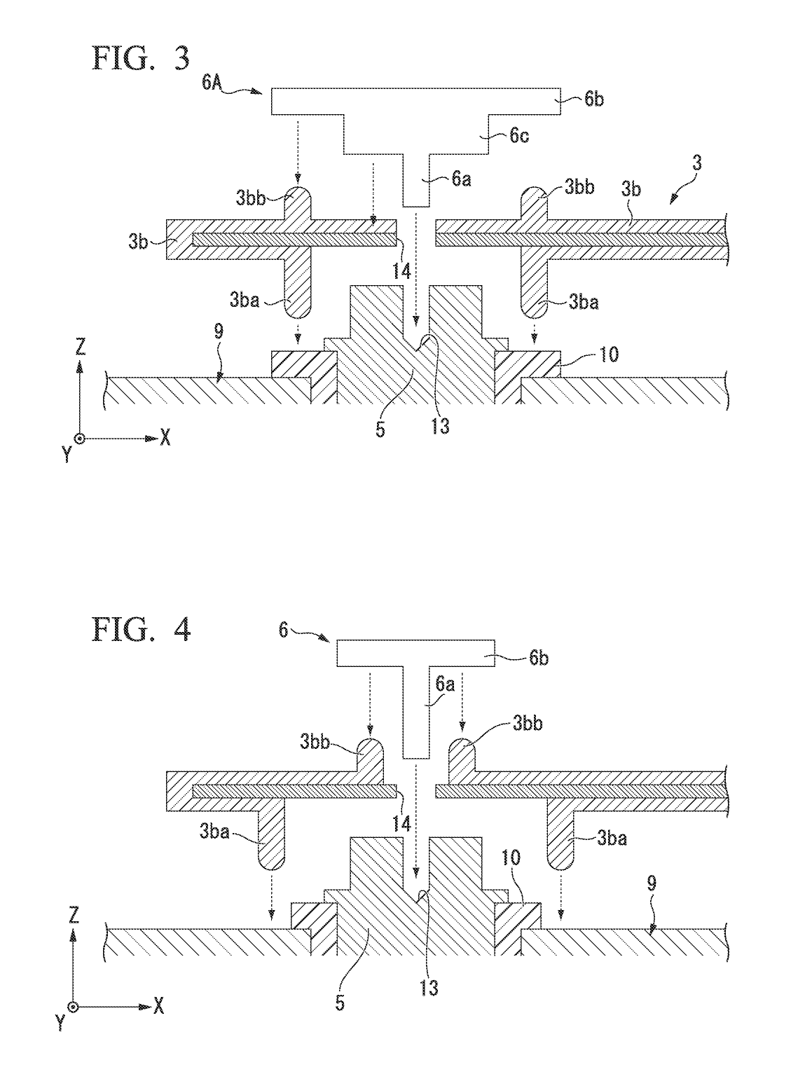

Furthermore, as to the battery module of the first embodiment, it is possible to modify the battery module to obtain a modified battery module illustrated in FIG. 3. FIG. 3 illustrates a diagram corresponding to FIG. 2B. The modified battery module in FIG. 3 is different from the battery module of the first embodiment at a point that a fixing member 6A is used instead of the fixing member 6. Since the other components of the modified battery module are the same as those of the battery module of the first embodiment, the same reference numerals are given to the same components in FIG. 3 and the description thereof will not be repeated here.

The fixing member 6A of FIG. 3 includes a second convex portion 6c that contacts the resin 3b on the interconnection member 3 between the convex portion 6a and the head portion 6b. The shape of the head portion 6b in the XY plane is a substantially circular shape with a diameter “L” of which the center is located at the convex portion 6a, and the shape of the second convex portion 6c in the XY plane is also a substantially circular shape of which the center is located at the convex portion 6a. But the diameter of the second convex portion 6c is smaller than the diameter “L”. The height of the second convex portion 6c along the Z direction is designed in order that the second projection 3bb sufficiently and evenly contacts the head portion 6b of the fixing member 6, that the air-tightness of the portion surrounded by the second projection 3bb is highly maintained, and that the second convex portion 6c completely contacts the resin 3b on the interconnection member 3, when the convex portion 6a of the fixing member 6 is inserted into the through-hole 14 of the interconnection member 3 and when the convex portion 6a is fitted to the concave portion 13 of the negative electrode terminal 5 to apply a pressure to the −Z direction. The convex portion 6a, the second convex portion 6c, and the head portion 6b may be integrally formed as one body by using a mold and made of metal or resin such as plastic.

According to this structure, the air-tightness may be highly maintained compared to the effect of the battery module of the first embodiment.

Further, as to the battery module of the first embodiment, it is also possible to modify the battery module to obtain a modified configuration illustrated in FIG. 4. FIG. 4 illustrates a diagram corresponding to FIG. 2B. The modified battery module in FIG. 4 is different from the battery module of the first embodiment at a point that the arrangement of the first projection 3ba and the second projection 3bb on the XY plane are different from the battery module of the first embodiment, although the second projection 3bb having substantially circular shape is formed on the bus-bar 3a at substantially the same position on the XY plane as that of the first projection 3ba in FIG. 2B. Specifically, in the XY plane of FIG. 4, the first projection 3ba and the second projection 3bb are formed in a substantially concentric circular shape, but the second projection 3bb has a smaller diameter than that of the first projection 3ba. Further, the first projection 3ba illustrated in FIG. 4 contacts the cover 9 instead of the insulating resin 10 and works as the O-ring, although the first projection 3ba illustrated in FIG. 2B contacts the insulating resin 10 and works as the O-ring. Since the other components are the same as those of the battery module of the first embodiment, the same reference numerals are given to the same components in FIG. 4, and the description thereof will not be repeated here.

With this structure, the air-tightness is appropriately maintained, even if the size of the fixing member 6, the diameter of the negative electrode terminal 5 in the XY plane, and the area covered by the resin 10 are different. Although there is a possibility that these sizes are changed to adopt a new design or a new model for the battery modules, the interconnection member 3 according to the modified battery module in FIG. 4 can be applied to a plurality of designs and models without further modification, once the interconnection member 3 is formed. Therefore, by using the modified battery module shown in FIG. 4, the cost performance in production is improved.

As described above, the battery modules of the first embodiment and the modified examples thereof have a configuration, that each of the electrode terminals (i.e., the positive electrode terminal or the negative electrode terminal) having the concave portion (e.g., a hole for screwing a screw or the like) and the fixing member 6 (e.g., a male screw or the like) having the convex portion, which is fitted to the concave portion, are fixed through the interconnection member 3, and that each of the electrode terminals and the interconnection member 3 are electrically connected to each other. However, the electrode terminal may have the convex portion and the fixing member may have the concave portion to be fitted to the convex portion, for the electrode terminal and the interconnection member to be fixed and electrically connected to each other. According to this modified example, specifically, the shape corresponding to the convex portion 6a of the fixing member 6 is formed with the electrode terminal as one body, and the fixing member having a concave portion corresponding to the shape, is fitted to the shape formed in the electrode terminal. Here, the shape is referred as “a convex portion formed on the electrode terminal”, and of course, in this case, the structure corresponding to the head portion 6b of the fixing member 6 is not connected to “the convex portion formed on the electrode terminal”, Since the concave portion of the fixing member is designed to evenly contact the second projection 3bb of the interconnection member 3, the air-tightness of the portion surrounded by the second projection 3bb is highly maintained. Of course, in order to maintain the air-tightness, the concave portion needs to be a concave instead of a through-hole or a pass passing through the fixing member. When the convex portion formed on the electrode terminal is a male screw, for example, a bag-shaped nut or a blind nut may be used as the fixing member having the concave portion to be fitted to the convex portion.

### Second Embodiment

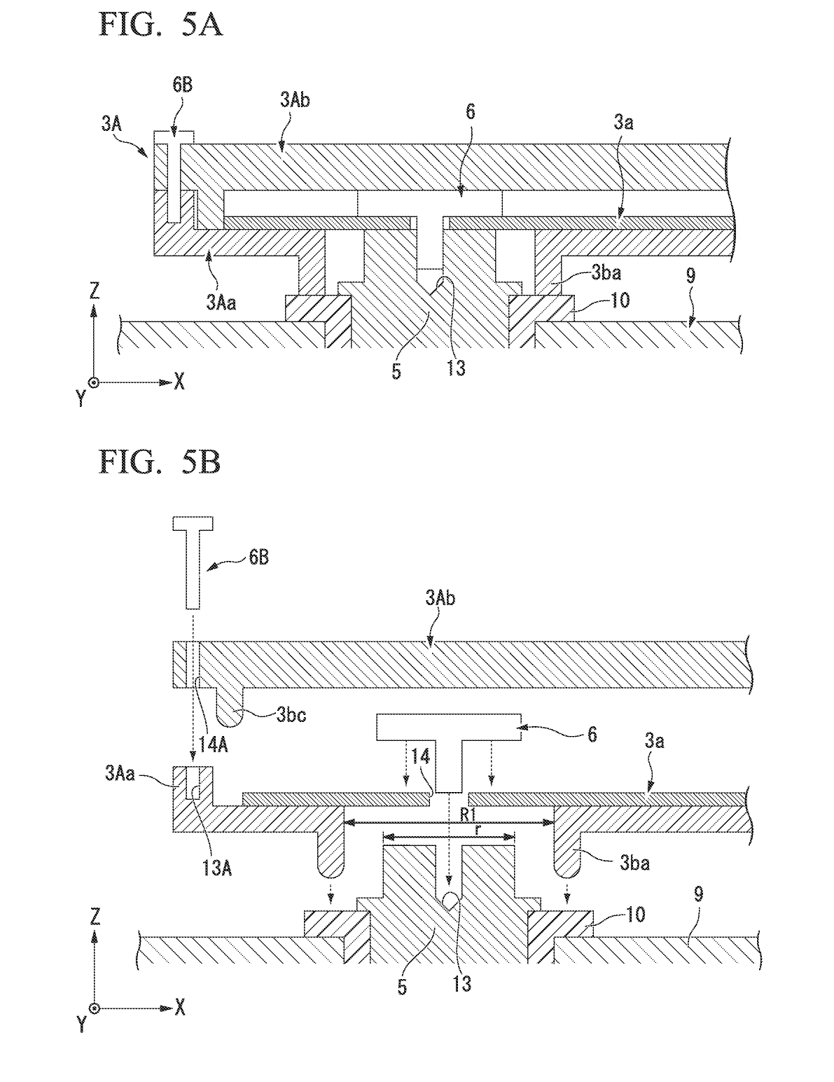

Referring to FIGS. 5A and 5B, a battery module of a second embodiment will be described. Diagrams in FIGS. 5A and 5B correspond to FIG. 2B illustrating the battery module of the first embodiment. In the battery module of the first embodiment, the resin 3b directly covers the substantially entire surface of the bus-bar 3a of the interconnection member 3. However, according to the battery module of the second embodiment, the resin 3b is divided into two portions and the two portions are assembled to each other to obtain the same effect as that of the battery module of the first embodiment. Since the other components are the same as those of the battery module of the first embodiment, the same reference numerals are given to the same components and the description thereof will not be repeated here.

FIG. 5A illustrates a diagram after assembling the battery module, and FIG. 5B illustrates a diagram just before the assembly. An interconnection member 3A includes the bus-bar 3a, a first resinous member 3Aa and a second resinous member 3Ab. The first resinous member 3Aa and the second resinous member 3Ab are assembled to sandwich the bus-bar 3a.

The first resinous member 3Aa is a plate-shaped waterproof resin (e.g., rubber or the like) that covers the rear surface of the bus-bar 3a entirely other than the through-hole 14 and the area within the range of the radius of (R1)/2 on the XY plane from the center of each of two through-holes 14 of the bus-bar 3a in the rear surface. The rear surface is closer to the electrical cell 2 between the two surfaces in the bus-bar 3a, that is, the surface located to the −Z direction. The first resinous member 3Aa includes a first projection 3ba, that is integrally formed with a plate-shaped portion of the first resinous member 3Aa as one body. Further, in each of both ends of the first resinous member 3Aa, two second concave portions 13A are formed respectively, each of that are fitted with a second fixing member 6B to be described later.

The second resinous member 3Ab is a plate-shaped waterproof resin (e.g., rubber or the like) that covers a front surface of the bus-bar 3a entirely. The front surface is opposite to the contact portion of the bus-bar 3a between the two surfaces in the bus-bar 3a, that is, the surface located to the +Z direction. The second resinous member 3Ab includes a second projection 3bc different from the second projection 3bb described in the first embodiment. The second projection 3bc is integrally formed with a plate-shaped portion of the second resinous member 3Ab as one body. In each of both ends of the second resinous member 3Ab, two second through-holes 14A are formed respectively. The second fixing member 6B described later is inserted into the second through-hole 14A corresponding to the second concave portion 13A. The number of the second through-holes 14A, the number of the second concave portions 13A, and the number of the second fixing members 6B are the same because they corresponds each other. However, they are not limited to four in each interconnection member 3A, and may be changed as needed. In general, when the number is four, the air-tightness is further improved.

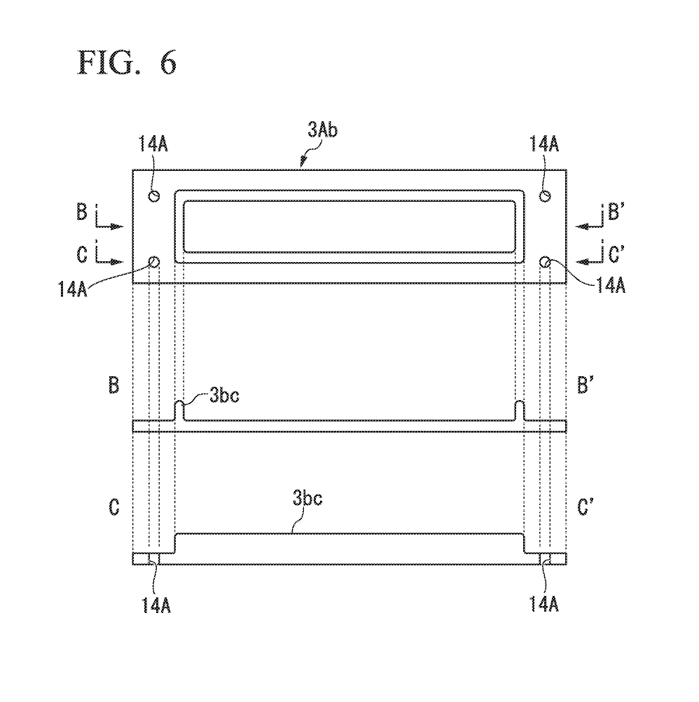

The details of the second resinous member 3Ab are illustrated in FIG. 6. FIG. 6 includes a plan view on the XY plane of the second resinous member 3Ab, a cross-sectional view with taken along the line B-B′ of the plane view, and a cross-sectional view with taken along the line C-C′ of the plane view. As illustrated in the drawings, the second projection 3bc is continuously formed in a substantially rectangular shape when it is seen from the XY plane. The size of the second projection 3bc in the XY plane and the height thereof in the Z direction are designed in order that the bus-bar 3a is arranged inside the substantially rectangular shape.

Specifically, the size of the substantially rectangular shape of the second resinous member 3Ab is larger than that of the bus-bar 3a in the XY plane. Further, the height of the second projection 3bc is larger than a thickness obtained by adding the thickness (in the Z direction) of the head portion 6b of the fixing member 6 and the thickness (in the Z direction) of the bus-bar 3a. Also, the height of the second projection 3bc is designed, in order that the second projection 3bc sufficiently and evenly contacts the first resinous member 3Aa, and that the second projection 3bc works as an O-ring and highly maintains the air-tightness of the portion surrounded by the second projection 3bc, when the fixing member 6B is inserted into the through-hole 14A of the second resinous member 3Ab and the fixing member 6B is fitted to the second concave portion 13A of the first resinous member 3Aa to apply a pressure in the −Z direction.

The first projection 3ba and the first resinous member 3Aa are both formed of a waterproof and elastic material, and are integrally formed as one body by using a mold. And the second projection 3bc and the second resinous member 3Ab are both formed of a waterproof and elastic material. and are integrally formed as one body by using a mold. The first resinous member 3Aa and the second resinous member 3Ab may be formed of the same material.

Accordingly, when two electrical cells are fixed to each other by using the interconnection member 3A and the fixing member 6B, the electric path between the electrical cells 2 is maintained to have high air-tightness by the waterproof resins 3Aa and 3Ab, the first projection 3ba, and the second projection 3bc of the interconnection member 3A. Therefore, the battery module exhibits excellent performance.

When the fixing member 6B is an elastic resin such as rubber having a convex portion of which the form is like a male screw, and when the diameter of the convex portion is designed to be substantially equal to or slightly larger than the diameter of the second concave portion 13A of the first resinous member 3Aa, the interconnection member 3A is reliably fixed to the electrical cell 2 and the air-tightness is highly maintained by pressing the fixing member 6B toward the first resinous member 3Aa.

Further, when the second concave portion 13A is a female screw and the convex portion of the fixing member 6A is a male screw engaging thereto, the second projection 3bc is more strongly pressed by turning the male screw into the femel screw until it do not go any further. Therefore, the function as the O-ring is further improved and the air-tightness is highly maintained. This embodiment is the same as the first embodiment in a point that the function of the first projection 3ba as the O-ring is obtained by the fixing member 6. Furthermore, even when the convex portion of the fixing member 6B is an elastic resin or a male screw, the interconnection member 3A is easily separated from the negative electrode terminal 5. Therefore, the effectiveness of the maintenance for the battery module becomes extremely satisfactory.

As described above, a battery module in the second embodiment has both of the waterproof property and effectiveness of maintenance at the same time and has an excellent battery performance, as the first embodiment. Furthermore, since the bus-bar 3a alone can be easily replaced unlike the battery module of the first embodiment, the battery module can be designed more flexibly. In the battery module of the second embodiment, the electrode terminal has the concave portion. However, the electrode terminal may have the convex portion as in the modified examples of the first embodiment.

In the battery modules of the first and the second embodiments and the modified examples, the battery module includes four electrical cells, but a battery module including two or more electrical cells may be used.

Further, the electrical cell has been described by exemplifying the lithium ion secondary electrical cell, but the invention may be applied to an electrical cell of any battery such as a primary battery or a secondary battery.

Furthermore, the electric path connecting the plurality of electrical cells has been described by exemplifying the conductive plate-shaped bus-bar as the interconnection material. However, a conductive wire can be used as the interconnection material. The shape of the electrode terminal has been described as the cylindrical shape, but may be changed to any shape in accordance with the design of the electrical cell. Accordingly, when the air-tightness in the electric path connecting the plurality of electrical cells 2 may be maintained, the convex portion, which works as the O-ring, may have any shape such as a circular shape, an oval shape, a rectangular shape, and a triangular shape on the XY plane.

While preferred embodiments and modified ones of the invention have been described and illustrated above, it should be understood that these are exemplary of the invention and are not limited. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A battery module comprising:
a first electrical cell and a second electrical cell, each including a battery case having an electrode terminal with one between a concave portion and a convex portion;
a fixing member for fitting to the one; and
an interconnection member including an interconnection material, a waterproof resin for covering the interconnection material other than a portion that the interconnection material contacts the electrode terminal, and a first projection extending from the waterproof resin and formed around the contact portion,
wherein the interconnection member is fixed between the first and the second electrical cells by the fitting, and
the first projection surrounds the electrode terminal to improve air-tightness of the interconnection member.

2. The battery module according to claim 1,
wherein the electrode terminal has the concave portion,
the fixing member has a convex portion corresponding to the concave portion and a head portion connected to the convex portion,
the interconnection material has a through-hole into for the convex portion to be inserted, and
the interconnection member is fixed with the head portion by the fitting.

3. The battery module according to claim 2,
wherein the interconnection member has a second projection at a portion contacting with the head portion, and
the second projection surrounds the convex portion to improve the air-tightness by the fitting.

4. The battery module according to claim 3,
wherein each of the first projection and the second projection works as an O-ring.

5. The battery module according to claim 4,
wherein the waterproof resin includes a first resinous member with the first projection and a second resinous member.

6. The battery module according to claim 5,
wherein the concave portion is a female screw and the convex portion is a male screw corresponding to the female screw.

7. A battery module comprising:
a first electrical cell and a second electrical cell, each including a battery case having an electrode terminal with one between a concave portion and a convex portion;
a fixing member for fitting to the one; and
an interconnection member including an interconnection material, a waterproof resin for covering the interconnection material other than a portion that the interconnection material contacts the electrode terminal, and a first projection extending from the waterproof resin and formed around the contact portion,
wherein the interconnection member makes the first electrical cell to keep a certain distance from the second electrical cell by the fitting, and
the first projection surrounds the electrode terminal to improve air-tightness of the interconnection member.

8. The battery module according to claim 7,
wherein the electrode terminal has the concave portion,
the fixing member has a convex portion corresponding to the concave portion and a head portion connected to the convex portion,
the interconnection material has a through-hole into for the convex portion to be inserted, and
the interconnection member is fixed with the head portion by the fitting.

9. The battery module according to claim 8,
wherein the interconnection member has a second projection at a portion contacting with the head portion, and
the second projection surrounds the convex portion to improve the air-tightness by the fitting.

10. The battery module according to claim 9,
wherein each of the first projection and the second projection works as an O-ring.

11. The battery module according to claim 10,
wherein the waterproof resin includes a first resinous member with the first projection and a second resinous member.

12. The battery module according to claim 11,
wherein the concave portion is a female screw and the convex portion is a male screw corresponding to the female screw.
